(19) United States
(12) Patent Application Publication
(10) Pub. No.: US 2016/0196051 A1
(43) Pub. Date: Jul. 7, 2016

(54) DISPLAY APPARATUS AND DISPLAYING METHOD THEREOF

(71) Applicant: SAMSUNG ELECTRONICS CO., LTD., Suwon-si (KR)

(72) Inventors: Kyeong-a HAN, Suwon-si (KR); Hee-jeong BAE, Osan-si (KR); Bo-la LEE, Seoul (KR)

(73) Assignee: SAMSUNG ELECTRONICS CO., LTD., Suwon-si (KR)

(21) Appl. No.: 14/987,177

(22) Filed: Jan. 4, 2016

(30) Foreign Application Priority Data
Jan. 2, 2015 (KR) 10-2015-0000193

(51) Int. Cl. G06F 3/0484

(52) U.S. Cl. CPC G06F 3/04847

(57) ABSTRACT

A display apparatus includes a display configured to display a plurality of screens, an input interface configured to receive a user input and a controller configured to, in response to receiving a predetermined user manipulation, control the display to display a UI for adjusting a size of at least one of the plurality of screens, and in response to receiving a screen control command through the input unit while the UI is displayed, control the display to adjust a size of at least one of the plurality of screens according to the screen control command.

### CROSS-REFERENCE TO RELATED APPLICATIONS

This application claims priority from Korean Patent Application No. 10-2015-0000193, filed in the Korean Intellectual Property Office on Jan. 2, 2015, the disclosure of which is incorporated herein by reference in its entirety.

### BACKGROUND

1. Field

Methods and apparatuses consistent with one or more exemplary embodiments relate to a display apparatus and a displaying method thereof, and more particularly, to a display apparatus for displaying a plurality of contents simultaneously and controlling the displayed contents effectively.

2. Description of the Related Art

Due to recent technological advancements, a display apparatus may be used not only to display broadcast contents but also to serve as a central device by being connected to various peripheral apparatuses. In addition, a display apparatus may allow users to watch various contents on the web via Internet connection. A display apparatus such as a TV has been advanced to be used as a smart TV by installing various applications, thereby enhancing its usability.

Resolution of the display apparatus has also been enhanced. For example, a Ultra High Definition (UHD) display apparatus has been introduced. The UHD refers to the resolution of 3840×2160. As the resolution has increased, the size of a display apparatus has also been enlarged.

Accordingly, a user may want to display various contents simultaneously on a large-sized display screen and controlling and use the displayed contents in a variety of ways.

### SUMMARY

One or more exemplary embodiments relate to a display apparatus capable of displaying a plurality of contents simultaneously and controlling the size of the screen where the contents are displayed easily, and a displaying method thereof.

According to an aspect of an exemplary embodiment, there is provided a display apparatus including a display configured to display a plurality of screens, an input interface configured to receive a user input; and a controller configured to, in response to receiving the user input corresponding to a predetermined user manipulation, control the display to display a user interface (UI) for adjusting a size of at least one screen among the plurality of screens, and in response to receiving a screen control command through the input interface while the UI is displayed, control the display to adjust a size of at least one screen among the plurality of screens, according to the screen control command.

The controller may be further configured to control the display to display a first screen and a second screen on the display, and in response to a pointer that corresponds to a location of a remote controller being located at a border between the first screen and the second screen, control the display to display the UI.

The controller may be further configured to, in response to receiving a user command to move the pointer in a direction of the first screen, control the display to reduce a size of the first screen and enlarge a size of the second screen.

The controller may be further configured to display the UI at a border between the first screen and the second screen, in response to receiving a user command through the input interface to move the UI in a direction of the first screen, control the display to reduce a size of the first screen and display the second screen on an area where the reduced first screen was previously displayed, and in response to receiving a user command before the UI displayed at the border reaches an edge of the display which contacts the first screen, control the display to display the second screen on a full area of the display.

The controller may be further configured to, in response to the pointer being located at an edge of the first screen while the first screen may be displayed on the full area of the display, control the display to display the UI on the edge, and in response to receiving a user command to move the pointer in a direction of an edge which is opposite to the edge, control the display to reduce a size of the first screen and display the second screen on an area where the reduced first screen was previously displayed.

The controller may be further configured to control the display to display a first screen and a second screen on the display, and in response to receiving a user command through the input interface to enter a screen control mode, control the display to display the UI on the first screen, in response to receiving a user command to press a first button that is included in the input interface, control the display to reduce a size of the first screen, and in response to receiving a user command to press a second button that is included in the input interface, control the display to enlarge a size of the first screen.

The remote controller may be realized as a pointing device, wherein the controller may be further configured to, in response to receiving a user command through the pointing device to select the UI and drag the pointing device in a direction of the first screen, control the display to reduce a size of the first screen and enlarge a size of the second screen.

According to an aspect of another exemplary embodiment, there is provided a displaying method of a display apparatus, including: displaying a plurality of screens; in response to receiving a predetermined user manipulation, displaying a user interface (UI) for adjusting a size of at least one screen among the plurality of screens; and in response to receiving a screen control command through an input interface while the UI is displayed, adjusting a size of at least one screen among the plurality of screens, according to the screen control command.

The displaying the plurality of screens may include displaying a first screen and a second screen, and wherein the displaying the UI may include, in response to a pointer that corresponds to a location of a remote controller being located at a border between the first screen and the second screen, displaying the UI.

The adjusting the size of at least one screen may include, in response to receiving a user command to move the pointer in a direction of the first screen, reducing a size of the first screen and enlarging a size of the second screen.

The displaying the UI may include displaying the UI at a border between the first screen and the second screen, wherein the adjusting the size of at least one screen may include, in response to receiving a user command through the input interface to move the UI in a direction of the first screen, reducing a size of the first screen and displaying the second screen on an area where the reduced first screen was previously displayed, and in response to receiving a user command before the UI displayed at the border reaches an edge of the display which contacts the first screen, displaying the second screen on a full area of the display.

The displaying the UI may include, in response to the pointer being located at an edge of the first screen while the first screen is displayed on the full area of the display, displaying the UI on the edge, wherein the adjusting the size of at least one screen may include, in response to receiving a user command through the input interface to move the pointer in a direction of an edge which is opposite to the edge, controlling the display to reduce a size of the first screen and display the second screen on an area where the reduced first screen was previously displayed.

The displaying the plurality of screens may include displaying a first screen and a second screen on the display, wherein the adjusting the size may include, in response to receiving a user command to enter a screen control mode, displaying the UI on the first screen, in response to receiving a user command to press a first button that is included in the input interface, reducing a size of the first screen, and in response to receiving a user command to press a second button that is included in the input interface, enlarging a size of the first screen.

The display apparatus may be controlled by a pointing device, wherein the displaying the plurality of screens may include displaying a first screen and a second screen, and wherein the adjusting the size of at least one screen may include, in response to receiving a user command to select the UI through the pointing device and drag the pointing device in a direction of the first screen, reducing a size of the first screen and enlarging a size of the second screen.

According to an aspect of another exemplary embodiment, there is provided a display apparatus including: a display configured to display a plurality of windows; an input interface configured to receive a user input; a controller configured to, in response to receiving a user input that corresponds to a predetermined function, display a user interface (UI) for adjusting a size of at least one window among the plurality of windows, and in response to receiving a user command for adjusting a window, adjust a size of at least one window among the plurality of windows.

The display may be configured to display at least three windows, and wherein the controller may be further configured to, in response to receiving a user command through the input interface to move the UI in a direction of a first window, control the display to reduce a size of the first window and enlarge a size of a second window and a third window.

The UI may be a thick line surrounding the window that is being controlled.

The UI may be a circle indicating a border between the plurality of windows.

According to the exemplary embodiments, a user may easily execute and end a screen mode for displaying a plurality of contents, and easily control a screen size of the plurality of contents which are displayed.

### BRIEF DESCRIPTION OF THE DRAWINGS

The above and/or other aspects will be more apparent by describing one or more exemplary embodiments with reference to the accompanying drawings, in which:

FIG. 1 is a block diagram illustrating a configuration of a display apparatus according to an exemplary embodiment;

FIG. 2 is a view illustrating a display apparatus displaying two contents simultaneously according to an exemplary embodiment;

FIGS. 3A to 4C are views illustrating a display apparatus in which screen size is adjusted through a screen control UI according to an exemplary embodiment;

FIGS. 5A to 5G are views illustrating a method of displaying a plurality of contents simultaneously and adjusting the size of the displayed contents according to an exemplary embodiment;

FIGS. 6A to 6F are views illustrating that a screen size is adjusted according to another exemplary embodiment;

FIGS. 7A and 7B are views illustrating a screen control UI in various forms according to an exemplary embodiment;

FIGS. 8A to 8D are views illustrating a method of displaying four contents simultaneously and adjusting the size of the displayed contents according to an exemplary embodiment; and

FIG. 9 is a flowchart illustrating a displaying method of a display apparatus according to an exemplary embodiment.

### DETAILED DESCRIPTION OF EXEMPLARY EMBODIMENTS

One or more exemplary embodiments will be described with reference to accompanying drawings. However, this does not limit the scope of the exemplary embodiments to a specific embodiment form. Modifications, equivalents and replacements may be employed.

Relational terms such as first and second, and the like, may be used to distinguish one entity from another entity, without necessarily implying any actual relationship or order of importance between such entities.

The terms used in the following description are provided to explain exemplary embodiments and are not intended to limit the scope of rights. A singular term includes a plural form unless it is expressly stated otherwise. The terms, “include”, “comprise”, “is configured to”, etc., may be used to indicate that there are features, numbers, steps, operations, elements, parts or combination thereof, and they should not exclude the possibilities of combination or addition of one or more features, numbers, steps, operations, elements, parts or combination thereof. Expressions such as “at least one of,” when preceding a list of elements, modify the entire list of elements and do not modify the individual elements of the list.

In an exemplary embodiment, ‘a module’ or ‘a unit’ performs at least one function or operation, and may be realized as hardware, software, or a combination thereof. In addition, a plurality of ‘modules’ or a plurality of ‘units’ may be integrated into at least one module and may be realized as at least one processor.

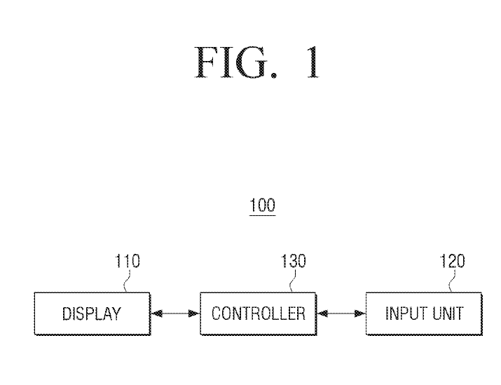

FIG. 1 is a block diagram illustrating a configuration of a display apparatus 100 according to an exemplary embodiment. As illustrated in FIG. 1, the display apparatus 100 may include a display 110, an input unit 120 (e.g., input interface) and a controller 130. In this case, the display apparatus 100 may be a TV, but this is only an example. The display apparatus 100 may be realized as a variety of electronic apparatuses with the display 110, such as a mobile phone, tablet PC, digital camera, camcorder, notebook PC, PDA, etc.

The display 110 displays an image. The display 110 may display contents which are received through a broadcast channel. For example, the display apparatus 100 may receive various broadcast signals transmitted from a broadcasting station through an RF (radio frequency) communication network, receive contents from various servers through an IP network, and display the received contents.

The display 110 may display a plurality of contents simultaneously. For example, if a user command to use two contents simultaneously is input, the display 110 may display two contents simultaneously in the same size or different sizes.

The input unit 120 receives a user command. The input unit 120 may receive a user command which is input remotely. The input unit 120 may be realized as an apparatus which includes at least one of four direction buttons, a touch pad, and a motion sensor. For example, the input unit 120 may be realized as a remote controller, a mobile apparatus such as a smart phone, or a pointing device.

Alternatively, the input unit 120 may include a camera or various sensors. The input unit 120 may receive a user command through a user's movement which is photographed using a camera, or may receive a user command according to a result sensed by various sensors.

The controller 130 controls the overall operations of the display apparatus 100. If a predetermined user manipulation is input through the input unit 120, the controller 130 may control the display 110 to display a size control UI to control the size of at least one of a plurality of screens. If a screen control command is input through the input unit 120 while the size control UI is displayed, the controller 130 may control the display 110 to adjust the size of at least one of a plurality of screens according to the size control command.

If a user command to display the second screen simultaneously is input while the first screen is displayed on the display 110, the controller 130 may control the display 110 to display the first screen of which display screen is reduced and the second screen simultaneously.

If a pointer corresponding to the location of a control apparatus is located at a border between the first screen and the second screen, the controller 130 may control the display 110 to display a size control UI.

If a user command to move the pointer in the direction of the first screen is input through the input unit 120, the controller 130 may control the display 110 to reduce the size of the first screen and enlarge the size of the second screen. The controller 130 may adjust the size of the first screen and the second screen while maintaining the horizontal and vertical ratio of the first and the second screen.

The controller 130 may control the display 110 to display a size control UI at a border between the first screen and the second screen. For example, the controller 130 may mark the border between the first screen and the second screen in a thick line and display a size control UI.

If a user command to move the size control UI in the direction of the first screen is input through the input unit 120, the controller 130 may control the display 110 to reduce the size of the first screen and display the second screen on an area where the reduced first screen was previously displayed.

If a user command is input before the size control UI displayed on the border reaches an edge of the display 110 which comes in contact with the first screen, the controller 130 may control the display 110 to display the second screen on the full area of the display 110.

If the pointer is located at an edge of the first screen while the first screen is displayed on the full area of the display 110, the controller 130 may control the display to display the size control UI at the edge of the first screen. If a user command to move the pointer in the direction of an edge which is opposite to the edge of the first screen is input through the input unit 120, the controller 130 may control the display 110 to reduce the size of the first screen and display the second screen on an area where the reduced first screen was previously displayed.

If a user command to enter a screen control mode is input through the input unit 120, the controller 130 may control the display to display the size control UI on the first screen. If a user command to press the first button included in the input unit 120 is input, the controller 130 may control the display 110 to reduce the size of the first screen, and if a user command to press the second button included in the input unit 120 is input, the controller 130 may control the display 110 to enlarge and display the first screen.

The above-described control apparatus may be realized as a pointing device. In other words, if a user command to select a UI and drag the UI in the direction of the first screen is input, the controller 130 may control the display 110 to adjust the size of the screens by reducing the size of the first screen and enlarging the size of the second screen.

As described above, by using the display apparatus 100, a user may use a plurality of contents simultaneously, and adjust the size of each of the displayed contents easily.

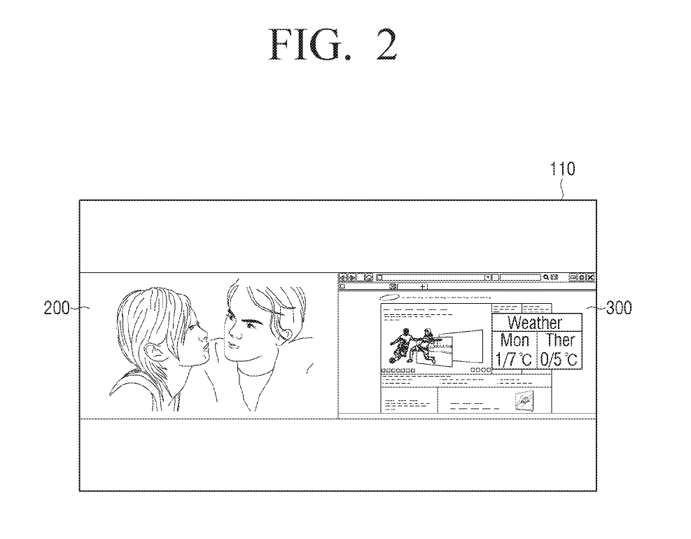

FIG. 2 is a view illustrating a display apparatus 100 for displaying two contents simultaneously according to an exemplary embodiment. In other words, the display apparatus 100 may display a broadcast content screen 200 and a web page screen 300 simultaneously.

If a user command to display two images is input while a broadcast content is displayed, the controller 130 may control the display 110 to display the two contents simultaneously as illustrated in FIG. 2.

The user command to display two images may be input by selecting a button which is provided on a control apparatus to control the display apparatus 100. For example, if a remote controller provides a button such as “mode”, a user may change to a mode in which the display apparatus 100 displays a plurality of images by pressing the button once.

In addition, the display apparatus 100 may display an On Screen Display (OSD) window. Accordingly, a user may change to a mode in which the display apparatus 100 displays two images through the displayed OSD window.

According to the above-described method, if a user command to display two contents is input while a broadcast content is displayed, the controller 130 may control to display the broadcast content screen and the web page screen 300 on the display 110 simultaneously as illustrated in FIG. 2.

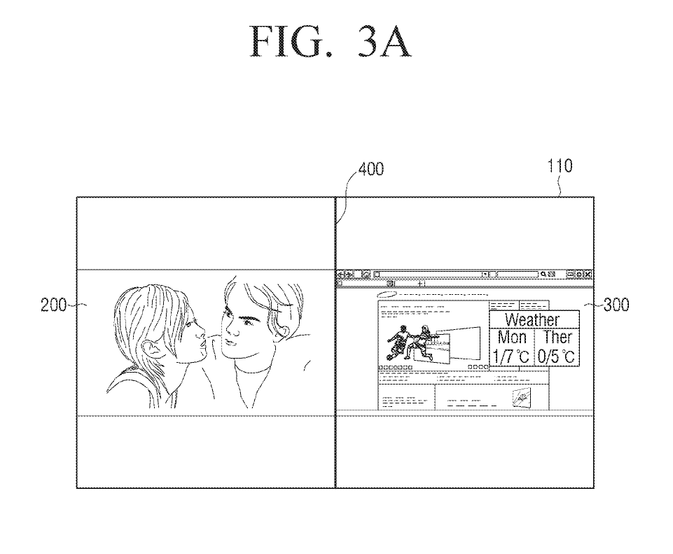

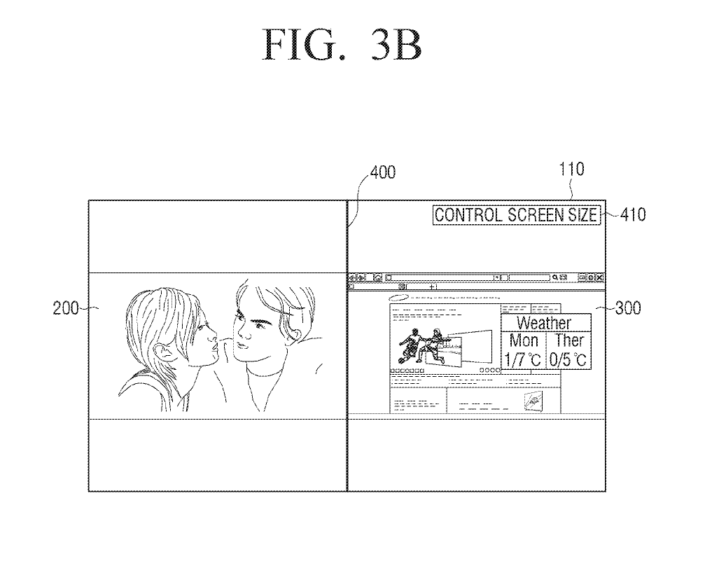

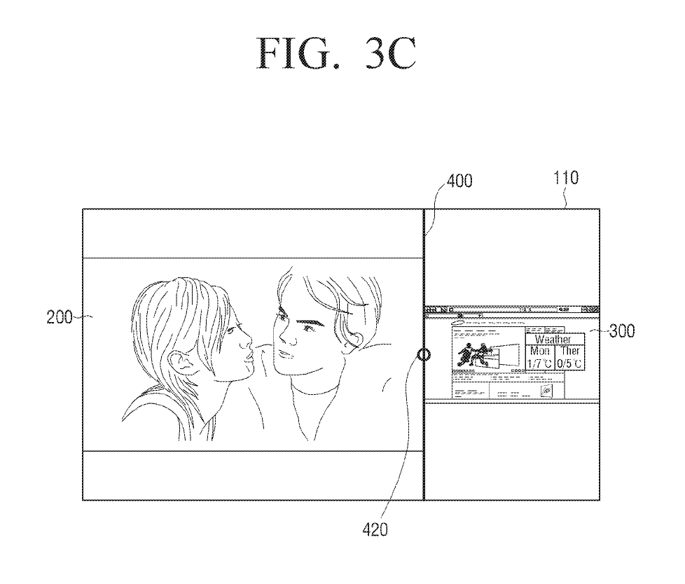

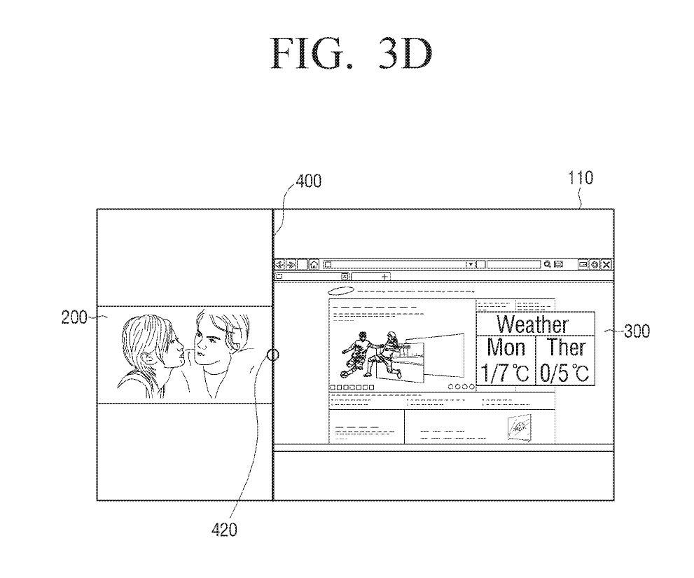

FIGS. 3A to 3D are views illustrating the display apparatus 100 of which screen size is adjusted through a screen control UI according to an exemplary embodiment.

FIG. 3A is a view illustrating the display apparatus 100 with a screen control UI 400. If a predetermined user manipulation is input, the controller 130 may control the display 110 to display the screen control UI 400 which is displayed in a thick line on the border between the two screens.

If a pointer corresponding to the location of an external control apparatus to control the display apparatus 100 is located at the border between the broadcast content screen 200 and the web page screen 300, the controller 130 may control the display 110 to display the screen control UI 400.

Here, the control apparatus is realized as a pointing device for convenience of explanation. If a pointing device is directed toward the display 110, the controller 130 may calculate the location of the pointer corresponding to the location of the pointing device. Accordingly, the controller 130 may display the pointer corresponding to the location of the pointing device on the display 110.

The controller 130 may display the pointer transparently. In other words, the controller 130 may display the pointer transparently, or control the display 110 to not display the pointer and display a separate UI corresponding to the location of the pointer when a specific condition is satisfied.

Accordingly, if the pointer corresponding to the location of the pointing device is located at the border between the broadcast content screen 200 and the web page screen 300, the controller 130 may display the screen control UI 400 which is displayed in a thick line at the border between the broadcast content screen 200 and the web page screen 300 as illustrated in FIG. 3A.

When the screen control UI is displayed and thus, the size of a screen is adjustable, the controller 130 may display a message that the screen size is adjustable. As illustrated in FIG. 3B, the controller 130 may control the display 110 to display a text 410 of “control screen size”.

Displaying the text 410 of “control screen size” is only an example, and the controller 130 may inform a user that the screen size is adjustable through other methods such as outputting an indicator when the screen size is adjustable.

FIGS. 3C and 3D are views illustrating that the size of a screen is adjusted according to an exemplary embodiment.

If a button, a touch pad, or a sensor is included in a pointing device, and a user command to select the screen control UI 400 is input through the button, the touch pad, or the sensor, the controller 130 may adjust the screen size according to the direction in which the pointing device moves. In addition, the controller 130 may add and display a UI 420 for informing that the user command to select the screen control UI 400 has been input. If the user command to select the screen control UI 400 is released through the above-described button, touchpad or sensor, the controller 130 may control the display 110 to display the screen control UI 400 as illustrated in FIG. 3A.

If a separate button is included in the pointing device, a user command to press the button is input, and the screen control UI 400 is moved in the direction of the web page screen 300 while the button is pressed, the controller 130 may control the display 110 to enlarge the broadcast content screen 200 and reduce the web page screen 300.

As illustrated in FIG. 3C, the broadcast content screen 200 may be enlarged as much as the screen control UI 400 moves in the direction of the web page screen 300, the web page screen 300 may be reduced accordingly.

On the other hand, if a user command to press the button is input, and the screen control UI 400 is moved in the direction of the broadcast content screen 200 while the button is pressed, the controller 130 may control the display 110 to enlarge the web page screen 300 and reduce the broadcast screen 200.

As illustrated in FIG. 3D, the web page screen 300 may be enlarged as much as the screen control UI 400 moves in the direction of the broadcast content screen 200, and the broadcast content screen 200 may be reduced accordingly.

When the user manipulation to press the button is stopped, the controller 130 may control the display 110 to delete the UI 420 which informs that the user command to select the screen control UI 400 has been input and display the screen control UI 400.

If a predetermined time has elapsed after the screen control UI is displayed, or a user command to delete the screen control UI 400 is input, the controller 130 may control the display 110 to delete the screen control UI 400 and display the broadcast content screen 200 and the web page screen 300 in a different screen size.

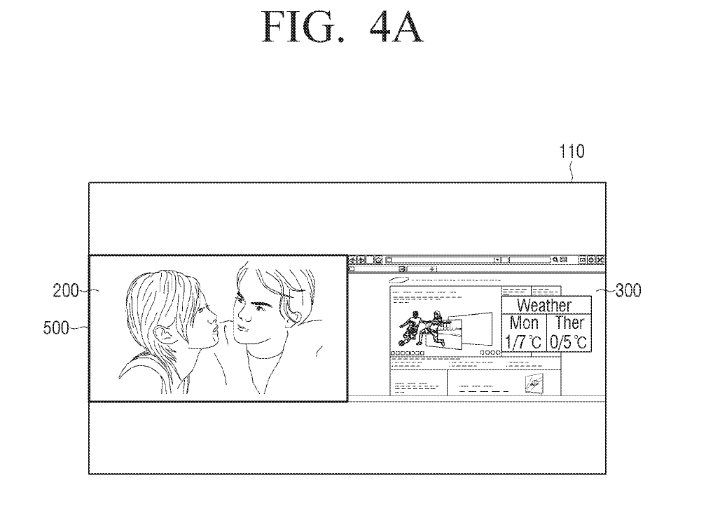

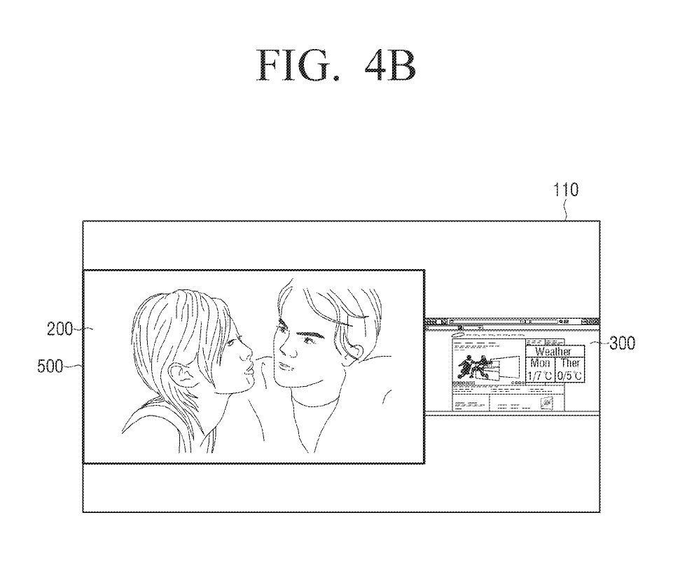

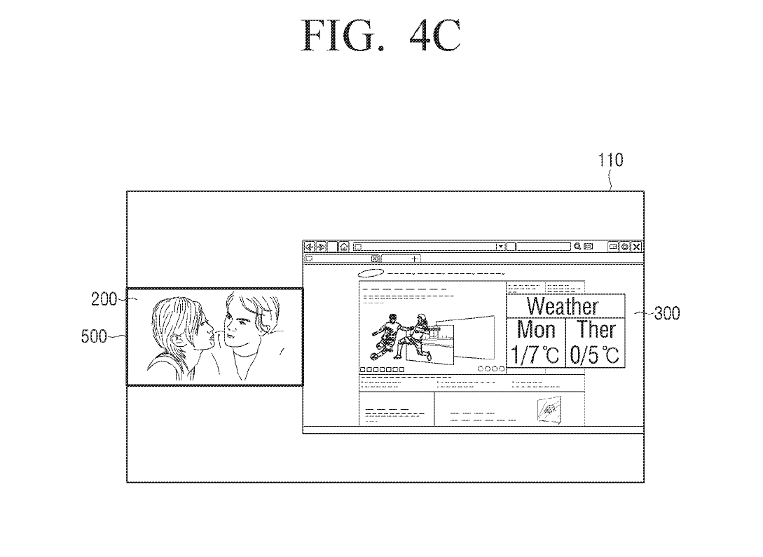

FIGS. 4A to 4C are views illustrating that the size of a screen is adjusted according to another exemplary embodiment.

FIG. 4A is a view illustrating the display apparatus 100 with a screen control UI 500. If a predetermined user manipulation is input, the controller 130 may control the display 110 to display the screen control UI 500 which causes the outline of one of the two contents to be displayed in a thick line.

The controller 130 may control the display 110 to display the screen control UI 500 according to a user command to press a separate button on an external control apparatus to control the display apparatus 100.

For example, if a user command to press “enter button” on the control apparatus is input, as illustrated in FIG. 4A, the controller 130 may control the display 110 to display the screen control UI 500 which causes the outline of the broadcast content screen 200 to be displayed in a thick line.

If a user command to select a left or right direction, the controller 130 may move the screen control UI 500 to the web page screen 300. For example, if four direction keys are included the control apparatus, and a user command to press the left or right direction key is input, the controller 130 may display the outline of the web page screen 300 in a thick line.

If a user command to enlarge or reduce a screen where the screen control UI 500 is displayed is input, the controller 130 may adjust the screen size as illustrated in FIGS. 4B and 4C.

For example, if a user command to press the upper-direction key is input, the controller 130, as illustrated in FIG. 4B, may control the display 110 to enlarge the broadcast content screen 200 where the screen control UI 500 is displayed and reduce the web page screen 300.

If a user command to press the down-direction key is input, the controller 130, as illustrated in FIG. 4C, may control the display 110 to reduce the broadcast content screen 200 where the screen control UI 500 is displayed and enlarge the web page screen 300.

However, a control apparatus with four direction keys is only an example, and the control apparatus is not limited to this. For example, it may include a touch pad or a toggle key, etc. Accordingly, a user may adjust a screen size by inputting a touch command in one direction or manipulating a toggle key.

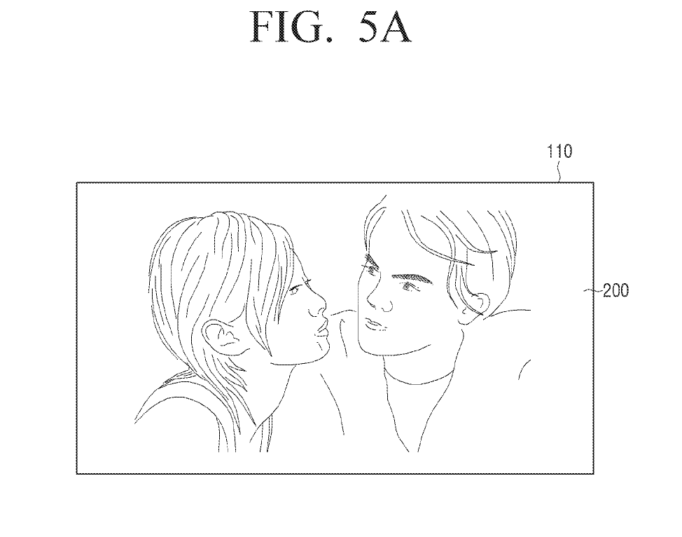

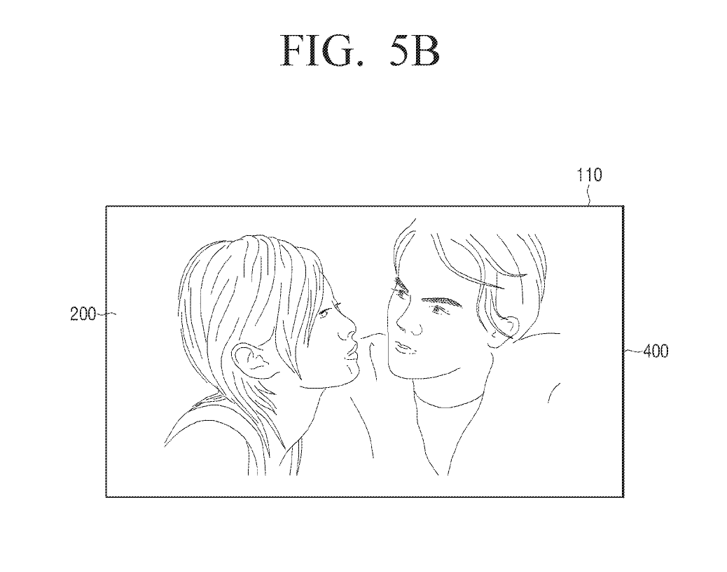

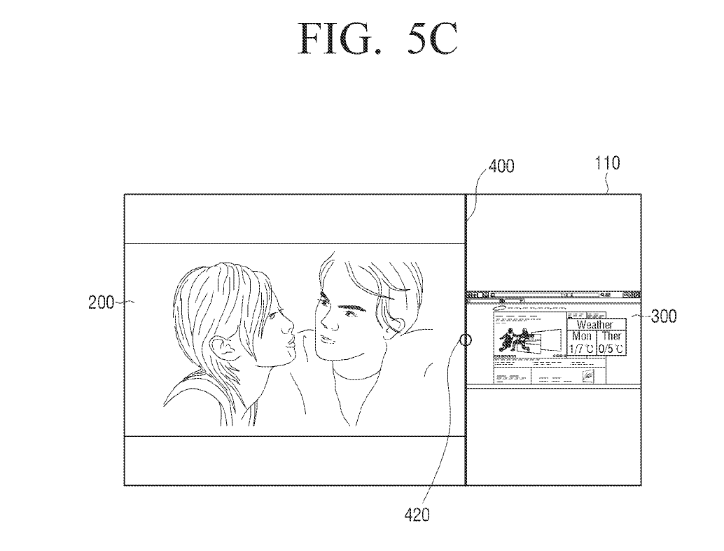

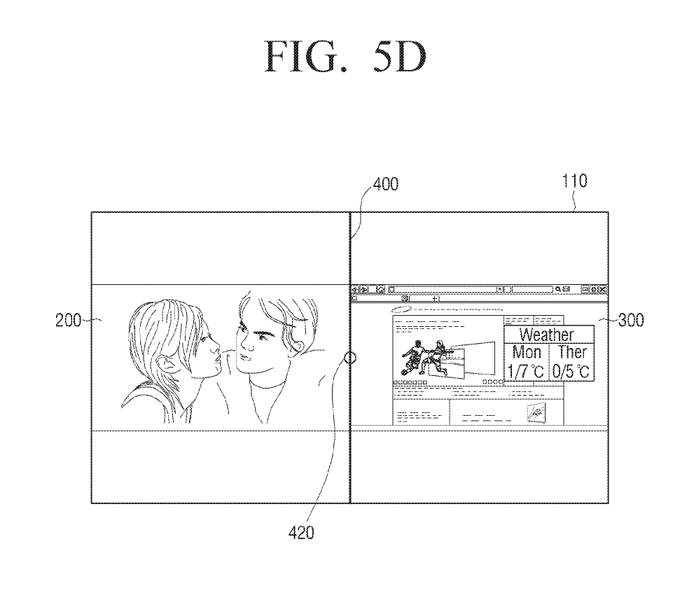

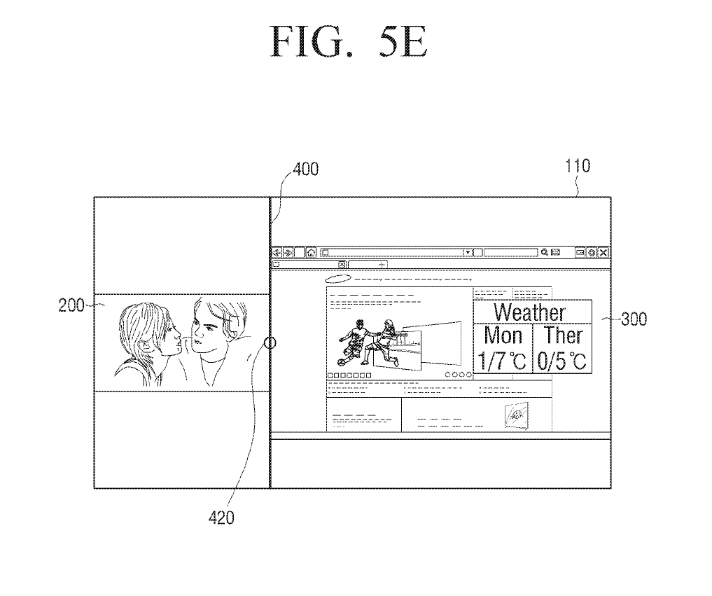

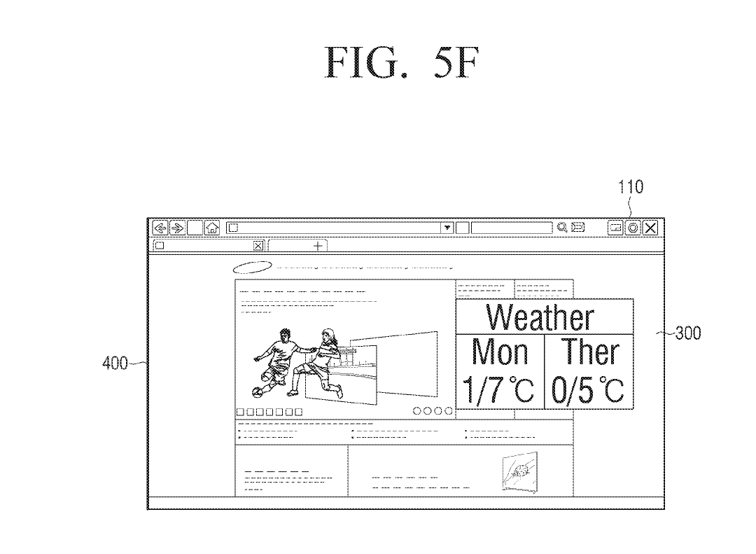

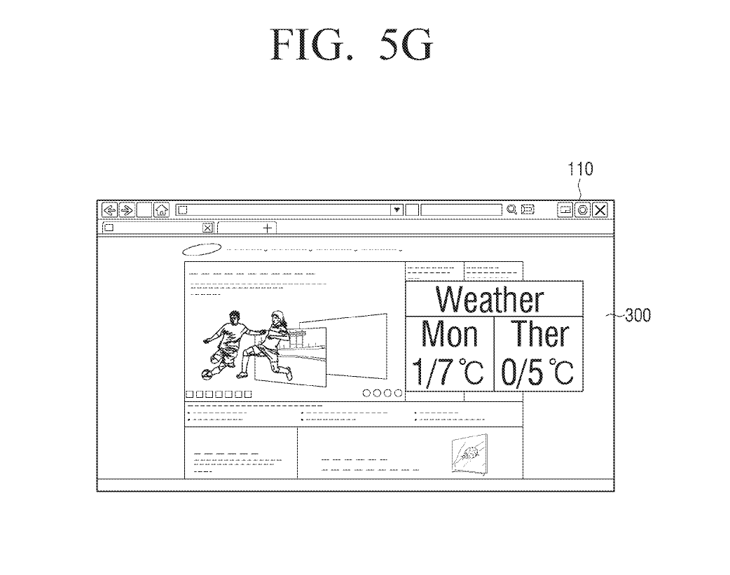

Below, the method of displaying a plurality of contents simultaneously and adjusting the size of the displayed contents will be described with reference to FIGS. 5A to 5G. Using a pointing device as a control apparatus to control the display apparatus 100 will be described as an example.

FIG. 5A is a view illustrating that the display apparatus 100 displays the broadcast content 200 according to an exemplary embodiment.

FIG. 5B is a view illustrating that a pointer corresponding to the location of a pointing device which is directed toward the display 110 is located at a right edge of the display 110.

The controller 130 may control to display the pointer corresponding to the location of the pointing device transparently. Alternatively, if the pointer is not located at a predetermined specific area, the controller 130 may control the display to not display the pointer.

If the pointer corresponds to a specific location of the display 110, the controller 130 may control the display 110 to display the pointer on the specific location.

Accordingly, if a pointer corresponding to the location of a pointing device is located at an edge of the display 110, the controller 130 may control to display the screen control UI 400 which is displayed in a thick line on the edge of the display 110 in accordance with the location of the pointer.

If a user manipulation to move the screen control UI 400 is input, the controller 130 may adjust the size of a content screen which is displayed in accordance with the location of the screen control UI 400.

If a button, a touch pad, or a sensor is included in a pointing device, and a user command to select the screen control UI 400 is input through the button, the touch pad, or the sensor, the controller 130 may adjust the screen size according to the direction in which the pointing device moves. In addition, the controller 130 may add and display the UI 420 for informing the user that the user command to select the screen control UI 400 has been input.

When a button is included with a pointing device, if a user command to press the button and the screen control UI 400 is moved in the left direction while the button is pressed, the controller 130, as illustrated in FIG. 5C, may control the display 110 to reduce the broadcast content screen 200 and display the web page screen 300 on an area where the reduced broadcast content screen 200 was previously displayed.

As illustrated in FIG. 5D, if a user command to move the screen control UI 400 up to the center of the display 110 while pressing the button is input, the controller 130 may control the display 110 to display the broadcast content screen 200 and the web page screen 300 which are in the same size simultaneously.

While the user is pressing the button, the UI 420 for informing an input of a user command to select the screen control UI 400 is displayed continuously.

As illustrated in FIG. 5E, if a user command to move the pointing device continuously so that the screen control UI 400 is moved in the left direction while pressing the button is input, the controller 130 may control the display 110 to reduce the broadcast content screen 200 and enlarge the web page screen 300.

If a user command to move the screen control UI 400 up to the edge of the left side of the display 110 while pressing the button is input, the controller 130 may control the display 110 to enlarge the web page screen 300 so that the web page screen 300 is displayed on the full area.

If a user manipulation of pressing the button of the pointing device is stopped, as illustrated in FIG. 5F, the controller 130 may control the display 110 to delete the UI 420 and display the screen control UI 400 on the left edge of the display 110.

When a predetermined time has elapsed after the screen control UI 400 is displayed or a separate user command to delete the screen control UI 400 is input, the controller 130 may control the display 110 to delete the screen control UI 400 and display the web page screen 300 on the full area as illustrated in FIG. 5G.

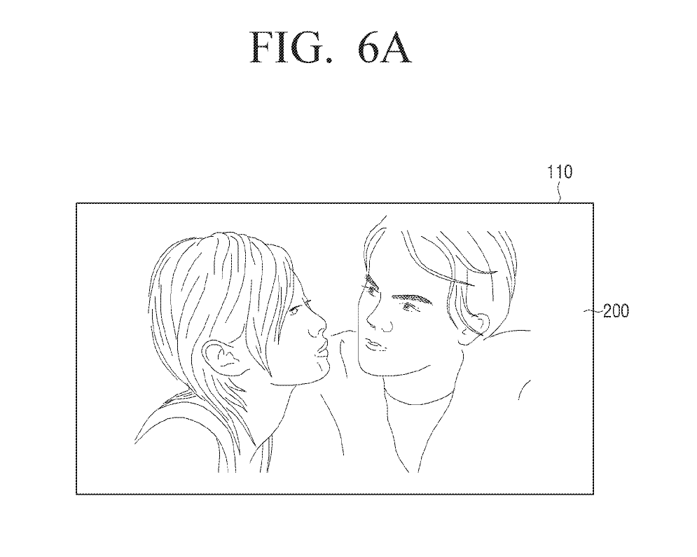

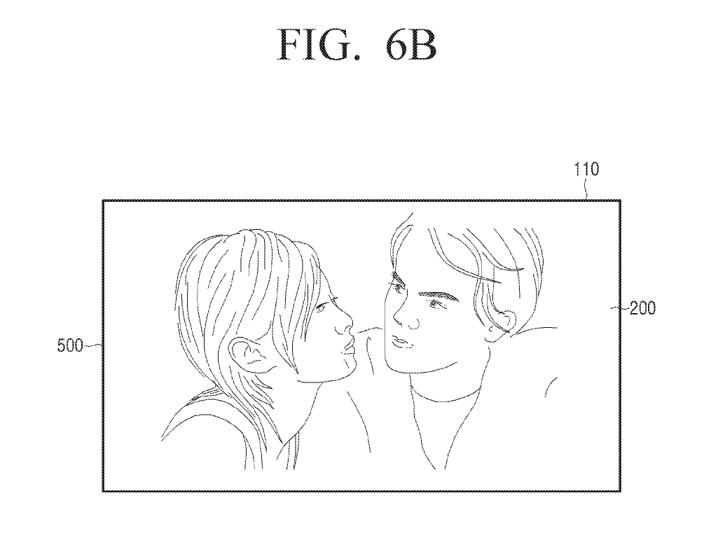

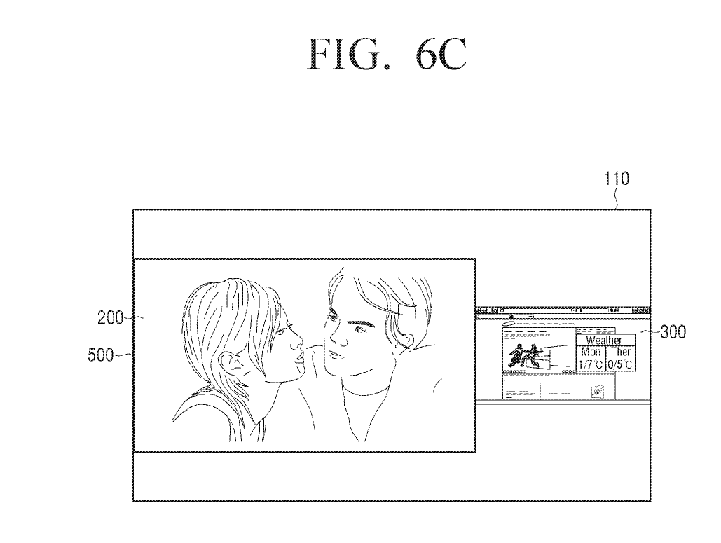

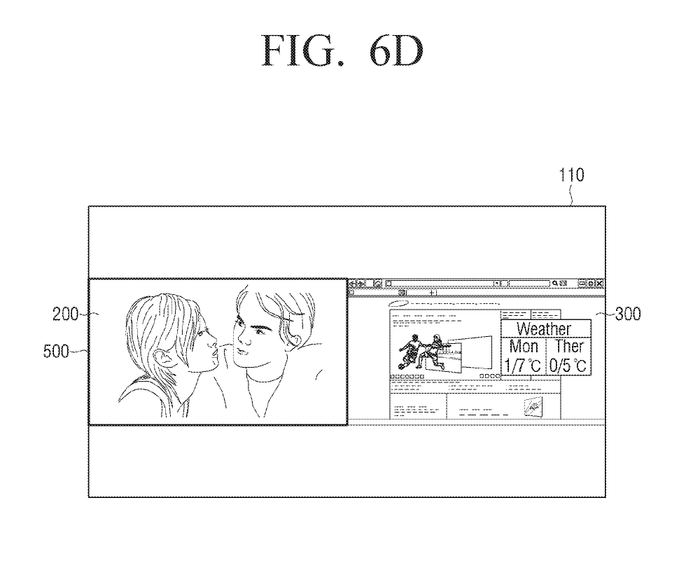

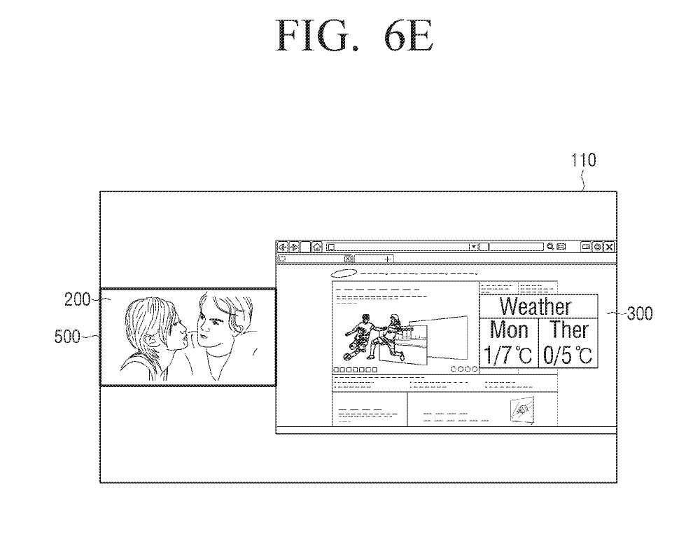

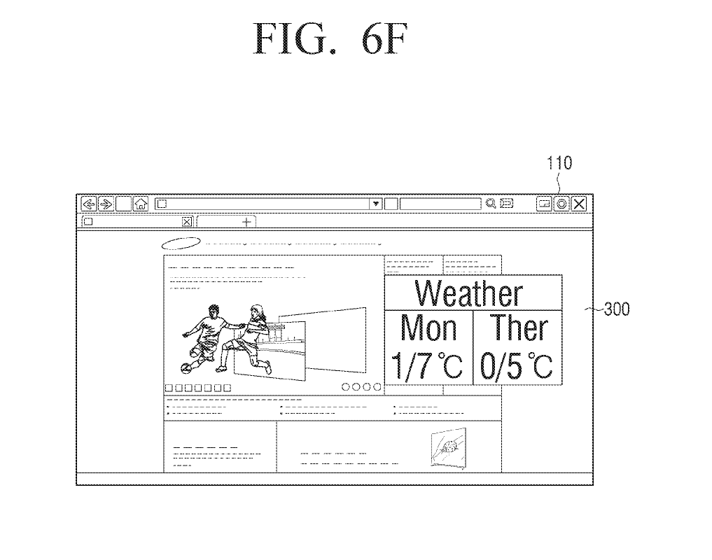

FIGS. 6A to 6F are views illustrating that a screen size is adjusted according to another exemplary embodiment.

FIG. 6A is a view illustrating that the display apparatus 100 displays the broadcast content screen 200 according to an exemplary embodiment.

FIG. 6B is a view illustrating the display apparatus 100 with the screen control UI 500 according to an exemplary embodiment. In other words, if a predetermined user manipulation is input, the controller 130 may control the display 110 to display the screen control UI 500 which is displayed in a thick line on the outline of the screen.

The controller 130 may control the display 110 to display the screen control UI 500 according to a user command to press a separate button provided on an external control apparatus to control the display apparatus 100.

For example, if a user command to press “enter button” on the control apparatus is input, as illustrated in FIG. 6B, the controller 130 may control the display 110 to display the screen control UI 500 which causes the outline of the broadcast content screen 200 to be displayed in a thick line.

If a user command to enlarge or reduce a screen where the screen control UI 500 is displayed is input, the controller 130 may control the screen size.

For example, if the control apparatus includes four direction keys and a user command to press the down-direction key is input, the controller 130, as illustrated in FIG. 6C, may control the display 110 to reduce the broadcast content screen 200 where the screen control UI 500 is displayed and display the web page screen on an area where the reduced broadcast content screen 200 was previously displayed.

If a user command to press the down-direction key is input continuously, the controller 130 may control the display 110 to reduce the size of the broadcast content screen 200 continuously according to the user command and display the web page screen 300 on an area where the reduced broadcast content screen 200 was previously displayed.

In other words, as illustrated in FIG. 6D, the controller 130 may reduce the size of the broadcast content screen 200 until the size of the broadcast content screen 200 becomes the same as that of the web page screen 300 and enlarge the size of the web page screen 300 according to the user command to press the down-direction key.

If the user command to press the down-direction key is input continuously, the controller 130, as illustrated in FIG. 6E, may control to reduce the size of the broadcast content screen 200 continuously and enlarge the size of the web page screen 300 continuously.

Consequently, the controller 130 may control the display 110 to display the web page screen 300 on the full area.

If a predetermined time has elapsed after the web page screen 300 is displayed on the full area of the display 110 or a separate user command to delete the screen control UI 500 is input, the controller 130 may delete the screen control UI 500 and as illustrated in FIG. 6F, control the display 110 to display the web page screen 300 on the full area without the screen control UI 500.

That the control apparatus includes the four direction keys is only an example, and the control apparatus may include a touch pad or a toggle key, etc. Accordingly, a user may adjust a screen size by inputting a touch command in one direction or manipulating a toggle key.

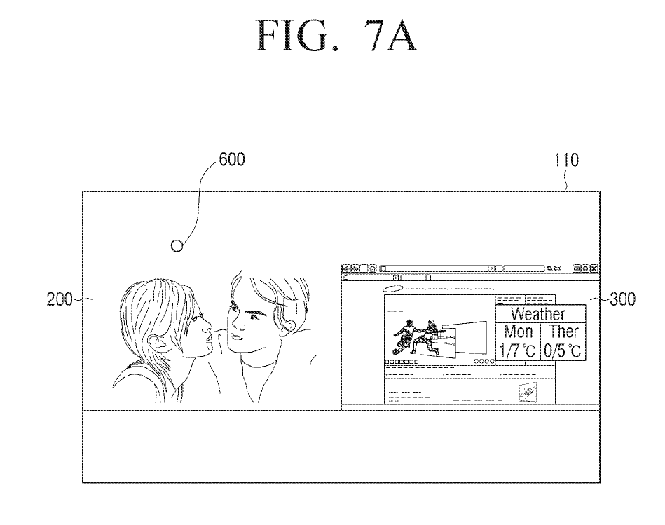

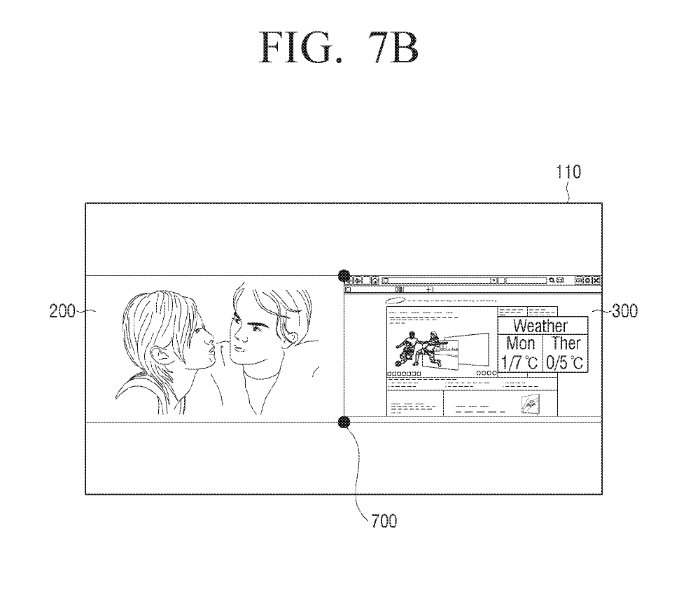

FIGS. 7A and 7B are views illustrating a screen control UI in various forms. As described above, a screen control UI may be realized not only in a straight thick line or in a square-shaped thick line but also in various forms and colors.

For example, as illustrated in FIG. 7A, an indicator 600 may be displayed on the upper part of a screen of which size is to be adjusted as a screen control UI.

In other words, if the indicator 600 is displayed on the upper part of the broadcast content screen 200 and a user command to enlarge the screen is input, the controller 130 may control the display 110 to enlarge the broadcast content screen 200 according to the user command and reduce the web page screen 300 as much as the broadcast content screen 200 is enlarged.

In addition, as illustrated in FIG. 7B, the screen control UI may be displayed not only in a thick line but also as a FIG. 700.

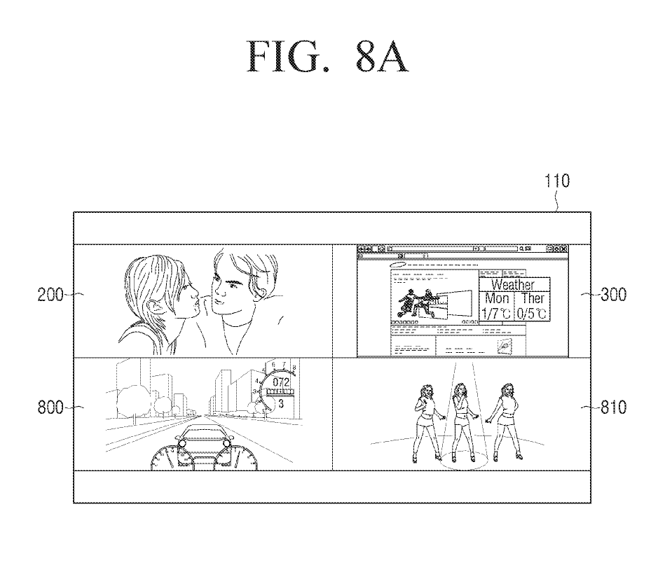

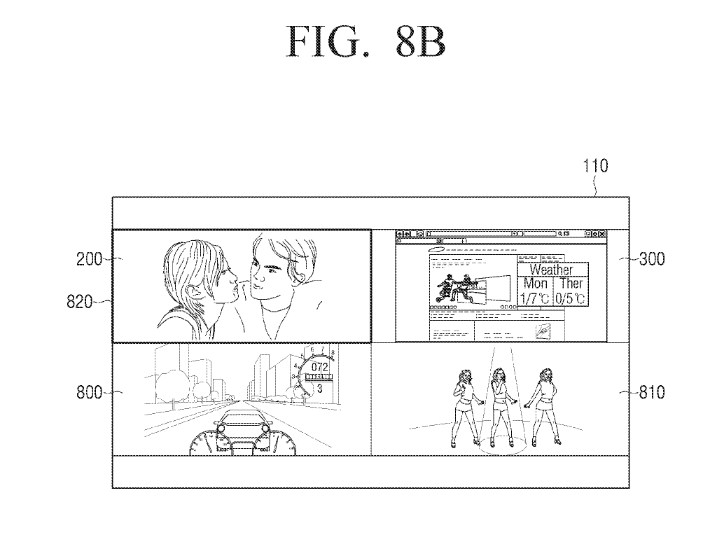

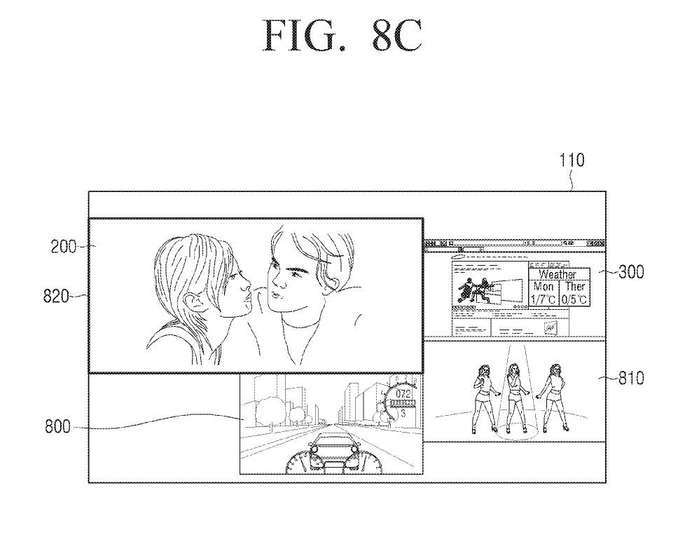

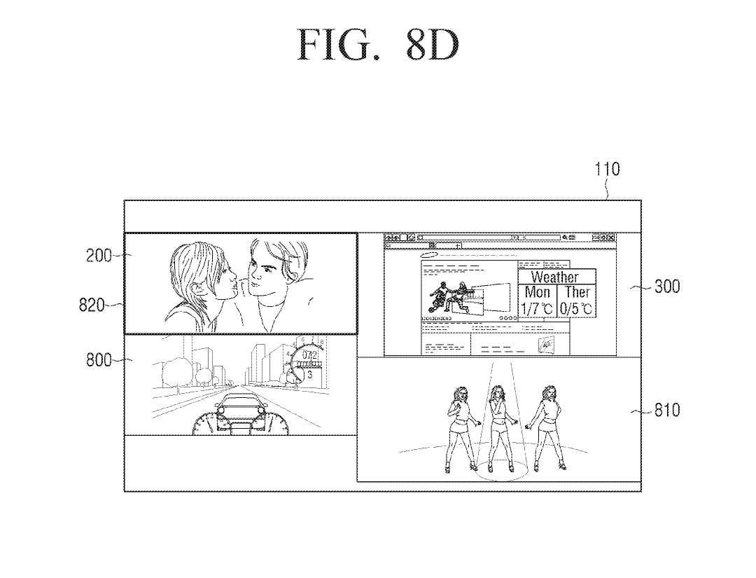

The display apparatus 100 may display more than three contents simultaneously. As illustrated in FIG. 8A, the display apparatus 100 may display four contents simultaneously.

When a plurality of contents are displayed simultaneously, the display apparatus 100 may divide the area of the display 110 into areas in the same size and display the plurality of contents on the divided areas.

Accordingly, when four contents are displayed in the same size, the size of each area of the contents may be adjusted according to the above-described user command.

For example, if a user manipulation to adjust a screen size is input, the controller 130, as illustrated in FIG. 8B, may control the display 110 to display a screen control UI 820, which causes one of the outlines of the four contents to be displayed in a thick line.

If a user command to enlarge the size of a content area where the screen control UI 820 is displayed is input, the controller 130 may control the display 110 to enlarge the size of the content area where the screen control UI 820 is displayed and reduce the size of the remaining contents as much as the size of the content where the screen control UI 820 is displayed is enlarged.

As illustrated in FIG. 8C, the controller 130 may control the display 110 to enlarge and display the broadcast content screen 200 where the screen control UI 820 is displayed. The controller 130 may control the display 110 to reduce the size of the remaining screens 300, 800, 810 except the broadcast content screen 200 corresponding to the enlarged size of the broadcast content screen 200.

On the other hand, if a user command to reduce the size of a content area where the screen control UI 820 is displayed is input, the controller 130 may control the display 110 to reduce the size of the content area where the screen control UI 820 is displayed and enlarge the size of the remaining content areas as much as the content area where the screen control UI 820 is displayed is reduced.

If more than three contents are displayed, the size of another content area besides the content area where the screen control UI 820 is displayed may be reduced.

In other words, as illustrated in FIG. 8D, the controller 130 may control the display 110 to reduce and display the broadcast content screen where the screen control UI 820 is displayed. In addition, the controller 130 may control the display 110 to reduce and display the screen 800 on the lower part of the broadcast content screen 200 just like the broadcast content screen 200.

Accordingly, the controller 130 may control the display 110 to enlarge and display the remaining screens 300, 810 on the lower part of the broadcast content screen 200.

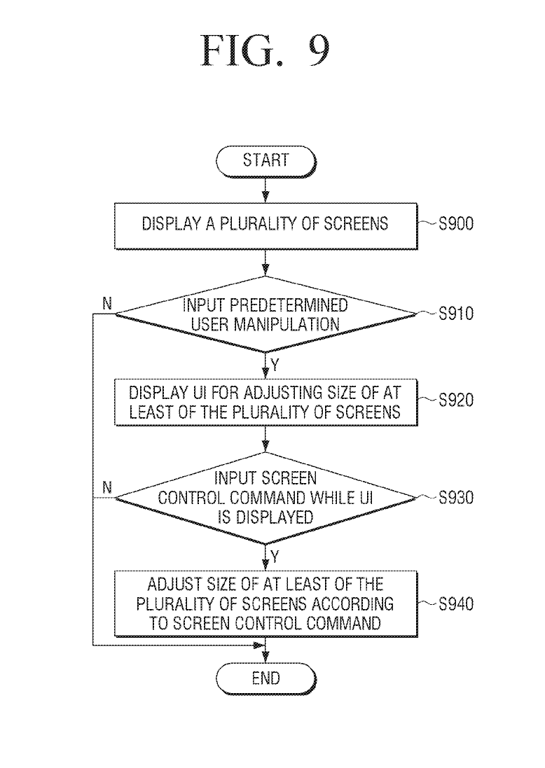

FIG. 9 is a flowchart illustrating a displaying method of a display apparatus according to an exemplary embodiment. First, the display apparatus 100 displays a plurality of screens (S900). If a user command to display two images is input while the first screen is displayed, the display apparatus 100 may display two contents simultaneously.

The user command to display two images may be input by selecting a button which is provided on a control apparatus to control the display apparatus 100. For example, if a button such as “mode” is provided on a remote controller, a user may press the “mode” button once to change the mode of the display apparatus 100 to a mode for displaying a plurality of images.

In addition, the display apparatus 100 may display an OSD window. Accordingly, a user may change the mode of the display apparatus 100 to a mode for displaying two images through the displayed OSD window.

If a user command to display two contents is input while the first screen is displayed according to the above-described method, the display apparatus 100 may control the display to display the first screen and the second screen on a display simultaneously.

If a predetermined user manipulation is input (S910-Y), the display apparatus 100 displays a UI for adjusting the size of at least one of the plurality of screens (S920).

The display apparatus 100 may display a UI by highlighting the first screen which has been displayed before the user command to display a plurality of contents was input. For example, the display apparatus 100 may display a UI by displaying the outline of the first screen in a thick line. Alternatively, the display apparatus 100 may display a UI by displaying the border between the first screen and the second screen in a thick line.

If a screen control command is input while the UI is displayed (5930-Y), the display apparatus 100 adjusts one of a plurality of screens according to the screen control command (S940).

A case in which the display apparatus 100 is controlled by using a pointing device will be described as an example. If the pointing device includes a button, a touch pad or a sensor, and a user command to select the UI using the button, the touch pad or the sensor is input, the display apparatus 100 may adjust the screen size according to the direction in which the pointing device is moved by a user.

Meanwhile, when the pointing device includes a button, if a user command to press the button is input and the pointing device is moved in the direction of the first screen while the button is pressed, the display apparatus 100 may control the display 110 to enlarge the second screen and reduce the first screen.

In other words, the display apparatus 100 may reduce the first screen and enlarge the second screen corresponding to an amount that the UI is moved in the direction of the first screen.

If a user command to press the button is input, and the pointing device is moved in the direction of the second screen while the button is pressed, the display apparatus 100 may enlarge the first screen and reduce the second screen.

The display apparatus 100 may reduce the second screen and enlarge the first screen as much as the UI is moved in the direction of the second screen.

If a user command to press the button is input and the pointing device is moved in the direction of the second screen continuously while the button is pressed, consequently, the display apparatus 100 may enlarge and display the first screen on the full area of the display 110.

If the first screen is displayed on the full area of the display 110, and the pointing device is moved in the direction of the first screen (that is, the opposite direction to the direction of the second screen) while the button is pressed, the display apparatus 100 may display the first screen and the second screen again simultaneously.

The elements of the above-described display apparatus 100 may be realized as software. For example, the display apparatus 100 may further include a flash memory or other non-volatile memory. The non-volatile memory may store a program corresponding to each element.

In addition, the controller 130 may be configured to include a CPU and Random Access Memory (RAM). The CPU of the controller 130 may copy the above-described programs stored in the non-volatile memory in the RAM and execute the copied programs to provide target information automatically as described above.

A display apparatus and a displaying method according to the above-described exemplary embodiments may be coded as software and stored in a non-transitory readable medium which can be mounted and used in various apparatuses.

The non-transitory recordable medium refers to a medium which may store data semi-permanently rather than storing data for a short time, such as register, cache, memory, etc., and is readable by an apparatus. The above-described various applications and programs may be stored and provided in a non-transitory recordable medium such as CD, DVD, hard disk, Blu-ray disk, USB, memory card, ROM, etc.

The exemplary embodiments are not to be construed as limiting the present disclosure. The one or more exemplary embodiments can be readily applied to other types of apparatuses. Also, the description of the exemplary embodiments is intended to be illustrative and not to limit the scope of the claims, and many alternatives, modifications, and variations will be apparent to those skilled in the art.

What is claimed is:

1. A display apparatus, comprising:
a display configured to display a plurality of screens;
an input interface configured to receive a user input; and
a controller configured to, in response to receiving the user input corresponding to a predetermined user manipulation, control the display to display a user interface (UI) for adjusting a size of at least one screen among the plurality of screens, and in response to receiving a screen control command through the input interface while the UI is displayed, control the display to adjust a size of at least one screen among the plurality of screens, according to the screen control command.

2. The apparatus as claimed in claim 1, wherein the controller is further configured to control the display to display a first screen and a second screen on the display, and
in response to a pointer that corresponds to a location of a remote controller being located at a border between the first screen and the second screen, control the display to display the UI.

3. The apparatus as claimed in claim 2, wherein the controller is further configured to, in response to receiving a user command to move the pointer in a direction of the first screen, control the display to reduce a size of the first screen and enlarge a size of the second screen.

4. The apparatus as claimed in claim 2, wherein the controller is further configured to display the UI at a border between the first screen and the second screen,
in response to receiving a user command through the input interface to move the UI in a direction of the first screen, control the display to reduce a size of the first screen and display the second screen on an area where the reduced first screen was previously displayed, and
in response to receiving a user command before the UI displayed at the border reaches an edge of the display which contacts the first screen, control the display to display the second screen on a full area of the display.

5. The apparatus as claimed in claim 2, wherein the controller is further configured to, in response to the pointer being located at an edge of the first screen while the first screen is displayed on the full area of the display, control the display to display the UI on the edge, and
in response to receiving a user command to move the pointer in a direction of an edge which is opposite to the edge, control the display to reduce a size of the first screen and display the second screen on an area where the reduced first screen was previously displayed.

6. The apparatus as claimed in claim 1, wherein the controller is further configured to control the display to display a first screen and a second screen on the display, and
in response to receiving a user command through the input interface to enter a screen control mode, control the display to display the UI on the first screen, in response to receiving a user command to press a first button that is included in the input interface, control the display to reduce a size of the first screen, and in response to receiving a user command to press a second button that is included in the input interface, control the display to enlarge a size of the first screen.

7. The apparatus as claimed in claim 2, wherein the remote controller is realized as a pointing device,
wherein the controller is further configured to, in response to receiving a user command through the pointing device to select the UI and drag the pointing device in a direction of the first screen, control the display to reduce a size of the first screen and enlarge a size of the second screen.

8. A displaying method of a display apparatus, comprising:
displaying a plurality of screens;
in response to receiving a predetermined user manipulation, displaying a user interface (UI) for adjusting a size of at least one screen among the plurality of screens; and
in response to receiving a screen control command through an input interface while the UI is displayed, adjusting a size of at least one screen among the plurality of screens, according to the screen control command.

9. The method as claimed in claim 8, wherein the displaying the plurality of screens comprises displaying a first screen and a second screen, and
wherein the displaying the UI comprises, in response to a pointer that corresponds to a location of a remote controller being located at a border between the first screen and the second screen, displaying the UI.

10. The method as claimed in claim 9, wherein the adjusting the size of at least one screen comprises, in response to receiving a user command to move the pointer in a direction of the first screen, reducing a size of the first screen and enlarging a size of the second screen.

11. The method as claimed in claim 9, wherein the displaying the UI comprises displaying the UI at a border between the first screen and the second screen,
wherein the adjusting the size of at least one screen comprises, in response to receiving a user command through the input interface to move the UI in a direction of the first screen, reducing a size of the first screen and displaying the second screen on an area where the reduced first screen was previously displayed, and
in response to receiving a user command before the UI displayed at the border reaches an edge of the display which contacts the first screen, displaying the second screen on a full area of the display.

12. The method as claimed in claim 9, wherein the displaying the UI comprises, in response to the pointer being located at an edge of the first screen while the first screen is displayed on the full area of the display, displaying the UI on the edge,
wherein the adjusting the size of at least one screen comprises, in response to receiving a user command through the input interface to move the pointer in a direction of an edge which is opposite to the edge, controlling the display to reduce a size of the first screen and display the second screen on an area where the reduced first screen was previously displayed.

13. The method as claimed in claim 8, wherein the displaying the plurality of screens comprises displaying a first screen and a second screen on the display,
wherein the adjusting the size comprises, in response to receiving a user command to enter a screen control mode, displaying the UI on the first screen, in response to receiving a user command to press a first button that is included in the input interface, reducing a size of the first screen, and in response to receiving a user command to press a second button that is included in the input interface, enlarging a size of the first screen.

14. The method as claimed in claim 8, wherein the display apparatus is controlled by a pointing device,
wherein the displaying the plurality of screens comprises displaying a first screen and a second screen, and
wherein the adjusting the size of at least one screen comprises, in response to receiving a user command to select the UI through the pointing device and drag the pointing device in a direction of the first screen, reducing a size of the first screen and enlarging a size of the second screen.

15. A display apparatus comprising:
a display configured to display a plurality of windows;
an input interface configured to receive a user input;
a controller configured to, in response to receiving a user input that corresponds to a predetermined function, display a user interface (UI) for adjusting a size of at least one window among the plurality of windows, and in response to receiving a user command for adjusting a window, adjust a size of at least one window among the plurality of windows.

16. The display apparatus of claim 15, wherein the display is configured to display at least three windows, and wherein the controller is further configured to,
in response to receiving a user command through the input interface to move the UI in a direction of a first window, control the display to reduce a size of the first window and enlarge a size of a second window and a third window.

17. The display apparatus of claim 15, wherein the UI is a thick line surrounding the window that is being controlled.

18. The display apparatus of claim 15, wherein the UI is a circle indicating a border between the plurality of windows.
